(19) United States
(12) Patent Application Publication
(10) Pub. No.: US 2015/0153503 A1
(43) Pub. Date: Jun. 4, 2015

(54) BACKLIGHT MODULE AND TRANSPARENT DISPLAY DEVICE COMPRISING THE SAME

(71) Applicant: InnoLux Corporation, Miao-Li County (TW)

(72) Inventor: Jian-Min LEU, Miao-Li County (TW)

(21) Appl. No.: 14/532,092

(22) Filed: Nov. 4, 2014

(30) Foreign Application Priority Data
Nov. 29, 2013 (TW) 102143698

(51) Int. Cl. F21V 8/00

(52) U.S. Cl. CPC G02B 6/0056; G02B 6/0035

(57) ABSTRACT

The present invention relates to a backlight module and a transparent display device comprising the same. The backlight module disclosed by the present invention comprises: a half-wave plate having a disposing surface; a light guide plate having a plurality of light guide units, the light guide units are adjacent to each other and are disposed on the disposing surface; and a light source irradiating a light into the light guide plate in the direction vertical to the normal line of the disposing surface.

### CROSS REFERENCE TO RELATED APPLICATION

This application claims the benefits of the Taiwan Patent Application Serial Number 102143698, filed on Nov. 29, 2013, the subject matter of which is incorporated herein by reference.

### BACKGROUND OF THE INVENTION

1. Field of the Invention

The present invention relates to a backlight module and a display device comprising the same, more particularly, to a backlight module for a transparent display device, and a transparent display device comprising the same.

2. Description of Related Art

With the increasing demand for various information media, a variety of lightweight flat panel displays are widely used, and since the liquid crystal display device has the advantages of low operating voltage, zero scattered radiation, light weight and small size, it has become the major display product in the recent years.

On the other hand, the demand for a transparent display device is gradually rising. This type of display device allows users to simultaneously see the display images of the display device and to see the objects behind the display device. Therefore, this type of display devices can be applied to the vehicle windshields, the household glass, or advertising boards, etc., to provide a more convenient way of accessing information.

Liquid crystal display device usually comprises a liquid crystal panel and a backlight module, wherein the backlight module provides a light source for the liquid crystal panel in order to achieve the function of displaying images. Currently, the backlight module used normally has a reflective substrate disposed at the bottom of the backlight module to reflect the light back to the light guide plate in order to increase the efficiency of the light source. However, in the case of a transparent liquid crystal display devices, the backlight source or the reflective substrate of a traditional backlight module hinders the transparency and reduce the perspective feature.

Therefore, a backlight module for the transparent display device characterized by excellent transparency is needed, thus the nature ambient light behind the display device is capable to penetrate through the backlight module and the liquid crystal panel, the display image from the display panel and the objects behind the display device can clearly presented to the users.

### SUMMARY OF THE INVENTION

The object of the present invention is to provide a backlight module, comprising: a half-wave plate having a disposing surface; a light guide plate having a plurality of light guide units, and the light guide units are arranged adjacently on the disposing surface; and a light source irradiating a light into the light guide plate in a direction vertical to a normal line of the disposing surface; wherein, each of the light guide units respectively comprises: an optical element having a light entrancing surface for an incident light; a first transparent plate disposed on the optical element, and having a first surface, wherein an angle between the first surface and the light entrancing surface is less than 90 degrees; a splitter disposed on the first surface, and reflecting portions of the incident light to the half-wave plate; and a second transparent plate disposed on the splitter, and having a light penetrating surface parallel to the light entrancing surface. According to an embodiment of the present invention, the light guide plate comprises the light guide units HᵢHₙ, which are sequentially stacked or arranged, and the intensity of reflecting light reflected from these light guide units H₁˜Hₙ is S₁˜ₙ respectively; wherein S₁=S₂=S₃=. . . =Sₙ=P₀/n; and wherein P₀ is the intensity of the light.

According to an embodiment of the present invention, when the optical element in the light guide unit is a half-wave plate, the half-wave plates in the light guide units H₁˜Hₙ rotate θ₁˜θₙ respectively in the same direction.

According to an embodiment of the present invention, when the light guide plate comprises the light guide units H₁˜Hₙ, which are sequentially stacked or arranged, and the intensity of reflected light reflected from these light guide units H₁˜Hₙ is S₁˜Sₙ respectively; a penetrating light penetrated from the light guide units H₁˜Hₙ deflect 2θ₁˜2θₙ degree respectively; and the intensity of the penetrating light is P₁˜P₁, respectively, wherein S₁˜Sₙ, 2θ₁˜2θₙ, and P₁˜Pₙ satisfy the following equation (I):

Sₘ=Pₘ₋₁×sin²(2θₘ)=P₀/n (I)

wherein Pₘ=Pₘ₋₁×cos²(2θₘ); and

m is an integer of 1˜n.

Another object of the present invention is to provide a transparent display device, comprising: a display panel; a backlight module disposed on one surface of the display panel, wherein the backlight module comprises: a half-wave plate having a disposing surface; a light guide plate having a plurality of light guide units, the light guide units are arranged adjacently on the disposing surface; and a light source irradiating a light into the light guide plate in a direction vertical to a normal line of the disposing surface; wherein, each of the light guide units respectively comprises: an optical element having a light entrancing surface for an incident light; a first transparent plate disposed on the optical element, and having a first surface, wherein an angle between the first surface and the light entrancing surface is less than 90 degrees; a splitter disposed on the first surface, and reflecting portions of the incident light to the half-wave plate; and a second transparent plate disposed on the splitter, and having a light penetrating surface parallel to the light entrancing surface.

### BRIEF DESCRIPTION OF THE DRAWINGS

FIG. 1˜FIG. 4 are a schematic views showing the method for preparing a light guide plate of a preferred embodiment of the present invention.

FIG. 5 and FIG. 6 show the structure of a light guide plate of a preferred embodiment of the present invention.

FIG. 7˜FIG. 8 show the structure of a backlight module of a preferred embodiment of the present invention.

FIG. 9 shows the structure of a backlight module of another preferred embodiment of the present invention.

FIG. 10 shows the structure of a transparent display panel of a preferred embodiment of the present invention.

### DETAILED DESCRIPTION OF THE PREFERRED EMBODIMENT

According to the specific embodiments of the following description, other advantages, and novel features of the invention will be apparent to those skilled in the art.

The present invention can also be accomplished by numerous other embodiments. It is to be understood that many other possible modifications and variations can be made without departing from the spirit and scope of the invention as hereinafter claimed.

### Embodiment 1

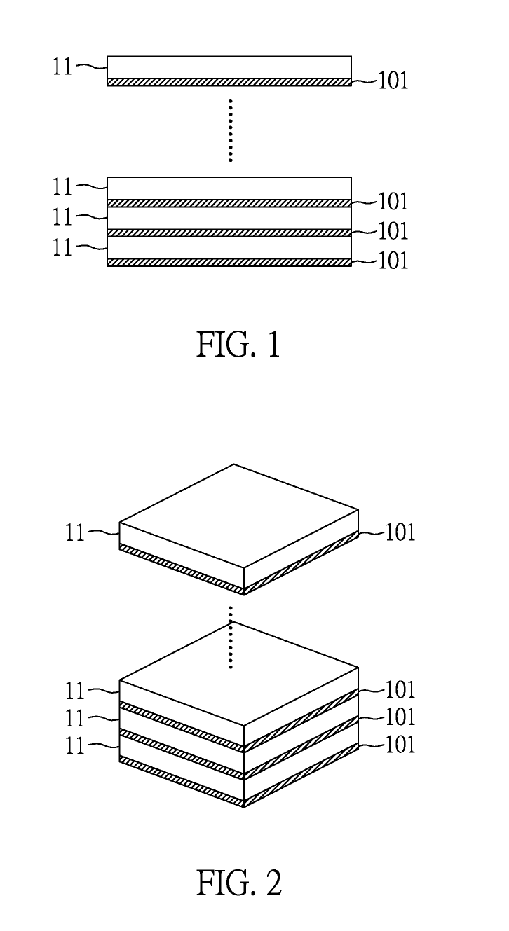

The stacked structures shown in FIG. 1 and FIG. 2 are formed by sequentially stacked optical element 101 and glass plate 11. In the present embodiment, optical element 101 is illustrated as a half-wave plate which rotates θ₁. However, in other embodiments, the optical unit may be a polarizer. Further, as shown in FIG. 3, the stacked structure is cut along border line A, wherein the angle between optical element 101 and the long axis of border line A is 45°. The optical element 101 is arranged tilted in an angle of 45° in the obtained sheet structure. In other embodiments, the angle between the long axis of border line A and optical element 101 may be less than 90°, preferably 30° to 60°, and most preferably 45°. Then, the steps illustrated above is repeated to prepare sheet structures in a number of n (not shown), and optical elements 102˜10n in these sheet structures are half-wave plates that respectively rotates θ₂ to θₙ. However, in other embodiments, these sheet structures may be polarizers; and in other embodiments, the sheet structures may be prepared in different numbers according to the size of the display panel or the design of the outward appearance. For example, when the number of the sheet structures is 10, the optical elements are half-wave plates that respectively rotates θ₁ to θ₁₀, wherein the rotate angles θ₁ to θ₁₀ of these half-wave plate must satisfy the conditions that illustrated below. Then, as shown in FIG. 4, the sheet structures are sequentially stacked, and splitters 12 are disposed between the adjacent sheet structures. In this embodiment, the splitter 12 is a multilayer structure formed by numeric SiO₂ films and HfO₂ films. However, in other embodiments, the splitter may be a splitter known in the art, and a polarization splitter known in the art is preferred.

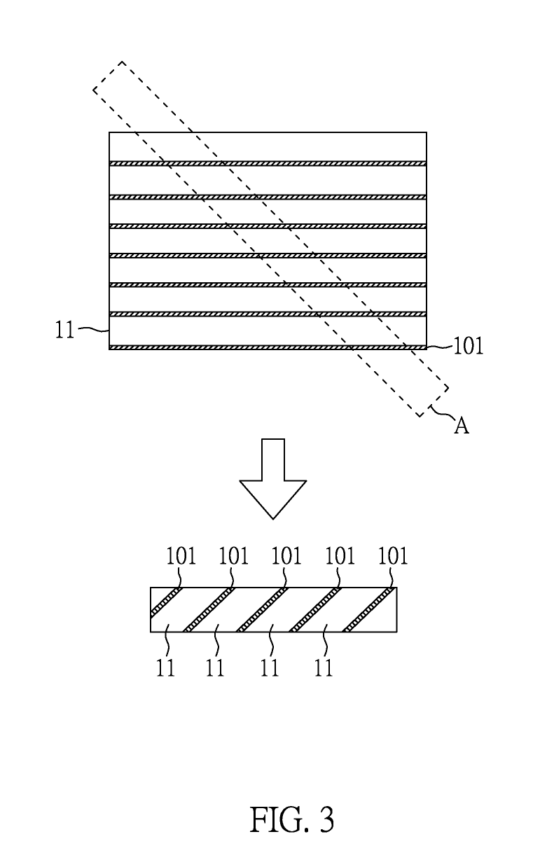

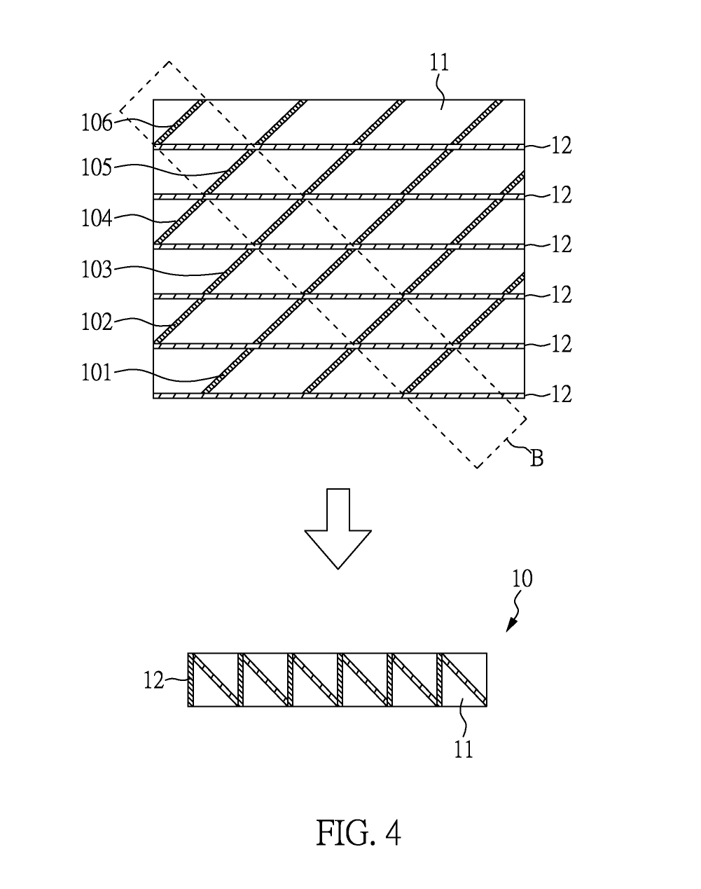

Next, as shown is FIG. 4, cut along border line B to obtain light guide plate 10, wherein the angle between the splitter 12 and the long axis of border line B is 40°. In other embodiments, the angle may be less than 90°, preferably between 30° to 60°, and most preferably 45°. Light guide plate 10 prepared by the above mentioned steps is shown in FIG. 5 and FIG. 6, which includes light guide units H₁˜Hₙ in a number of n. Light guide units H₁˜Hₙ respectively includes optical elements 101˜10n which are half-wave plates that rotate θ₁˜θₙ, and light guide units H1˜Hn respectively include optical units 101˜10n, which are half-wave plates that respectively rotate θ₁˜θₙ, optical units 101˜10n respectively include light incident surfaces 1011˜10n1 that provide a surface for the incident light; a plurality of first transparent plate 111, which respectively disposed on optical elements 101˜10n, and the angles between first surfaces 1111 of transparent plates 111 and light incident surfaces 1011˜10n1 of optical elements are 45°, wherein the first transparent plates 111 are made of glass; a plurality of splitter 121˜12n, which are respectively disposed on first surfaces 1111 of first transparent plates 111 in sequence; and a plurality of second transparent plate 112, which are respectively disposed on splitters 121˜12n, and light penetrate surfaces 1121 of each second transparent plates 112 are parallel to light incident surface 1011-10n1 of optical elements 101˜10n, wherein second transparent plates 112 are made of glass. In other embodiments, first transparent plates 111 or second transparent plates 112 may be made of the transparent materials in the art, such as transparent plastic materials. In addition, in other embodiments, the angles between first surfaces 1111 of each first transparent plate 111 and light incident surfaces 1011-10n1 of optical elements may be less than 90°, and preferably 30° to 60°.

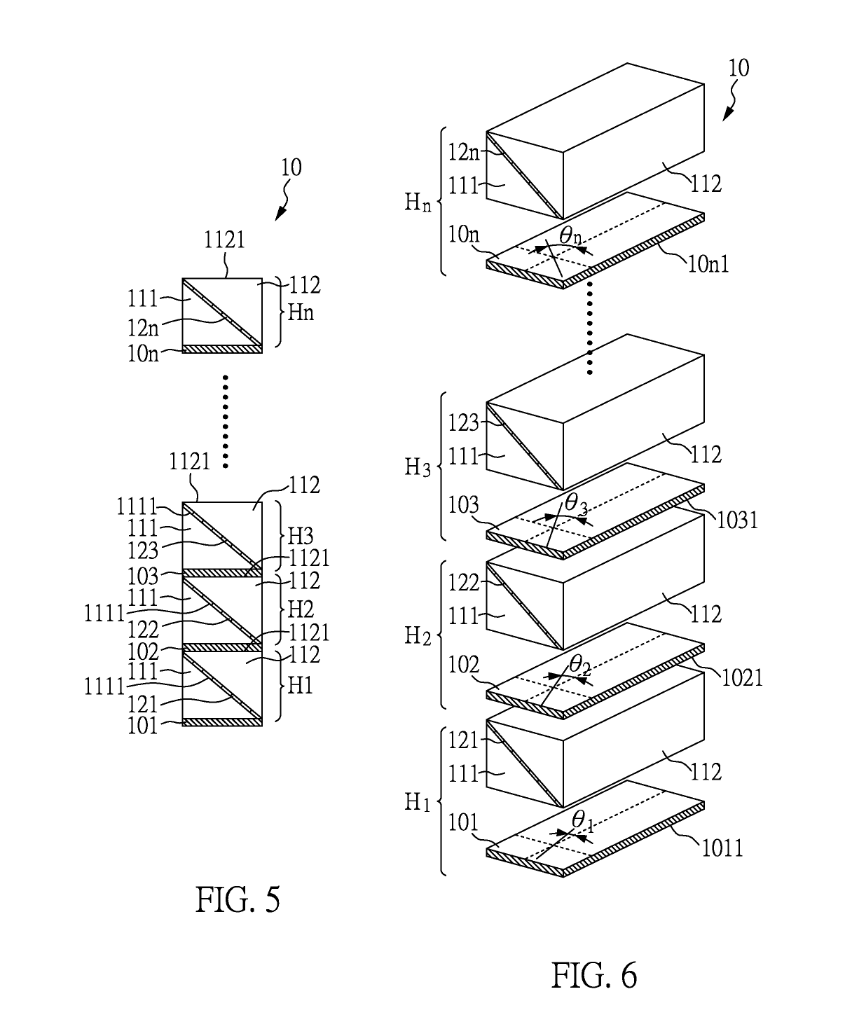

Then, the accomplished light guide plate 10 is disposed on disposing surface 212 of half-wave plate 21 to obtain a backlight module 20. Referring now to FIG. 7 and FIG. 8, a light source S₀ emit an incident light L₀ to light guide plate 10 in a direction of a normal line vertical to the disposing surface 212, incident light L₀ is a polarized light and its polarization direction is shown in FIG. 8 with a light intensity of P₀. When incident light L₀ penetrates through optical element 101 of first light guide unit H₁, incident light L₀ penetrate through a half-wave plate that rotates θ₁, therefore the polarization direction of incident light L₀ rotates 2θ₁. Then, referring now to FIG. 7, when incident light L₀ go through splitter 121, and a portion of incident light L₀ penetrates through splitter 121, the intensity of penetrating light L₁ is represented as P₁; another portion of incident light L₀ is reflected to the half-wave plate 21 by splitter 121, and the intensity of reflected light R₁ is represented as S₁, and they satisfy the following equation: P₁=P₀×cos²(2θ₁), S₁=P₀×sin²(2θ₁). Further, when penetrating light L₁ continues to proceed and penetrate through optical element 102 of light guide unit H₂, the polarization direction of penetrating light L₁ rotate 2θ₂ since the optical element 102 is a half-wave plate that rotates θ₂, (as shown in FIG. 8). Further, when penetrating light L₁ go through splitter 122, and a portion of incident light L₁ penetrates through splitter 122, the intensity of penetrating light L₂ is represented as P₂; another portion of incident light L₁ is reflected to the half-wave plate 21 by splitter 122, and the intensity of reflected light R₂ is represented as S₂, and the satisfy the following equation: P₂=P₁×cos²(2θ₂), S₂=P₁×sin²(2θ₁), and so on. When the light reaches light guide unit Hₙ, the intensity of penetrating light Lₙ, which goes through splitter 12n of light guide unit Hₙ, is Pₙ=Pₙ₋₁ ×cos²(2θₙ), and the intensity of reflected light R₁ is Sₙ=Pₙ₋₁×sin²(2θₙ).

In order to achieve a uniform light guiding property, the intensity S₁˜Sₙ of reflected light R₁˜Rₙ reflected by splitters 121˜12n of light guide units H₁˜Hₙ should by identical. Therefore, the intensity S₁˜Sₙ should satisfy the following equation:

S₁=S₂=S₃= . . . =Sₙ=P₀/n.

Since Sₘ=Pₘ₋₁×sin²(2θₘ), wherein m is an an integer of 1˜, Pₘ₋₁×sin²(2θₘ)=P₀/n can be inferred. In this embodiment, each optical element 101˜10n, that is, the rotation angle of each half-wave plate of the light guide plate should satisfy the above equation, thus incident light L₀ is uniformly dispersed to half-wave plate 21.

Half-wave plate 21 rotates an angle of φ, and the intensities of the ambient light that penetrate through the backlight module and the back light that penetrate through the backlight module can be adjusted by controlling the rotation angle of half-wave plate 21. For example, the intensity of the original ambient light is Ia₀, and the intensity of the ambient light observed by the user is Iₐ, wherein Iₐ=Iₐ₀×cos²(2φ); and the intensity of the original backlight is I_{b0}, and the intensity of the backlight observed by the user is I_{b}, wherein I_{b}=I_{b0}×sin²(2φ). The ambient light Iₐ penetrating from the back of the transparent display panel is preferred to be 50%-90% of the entire light that users observed, so that the objects behind the transparent display panel can be clearly seen.

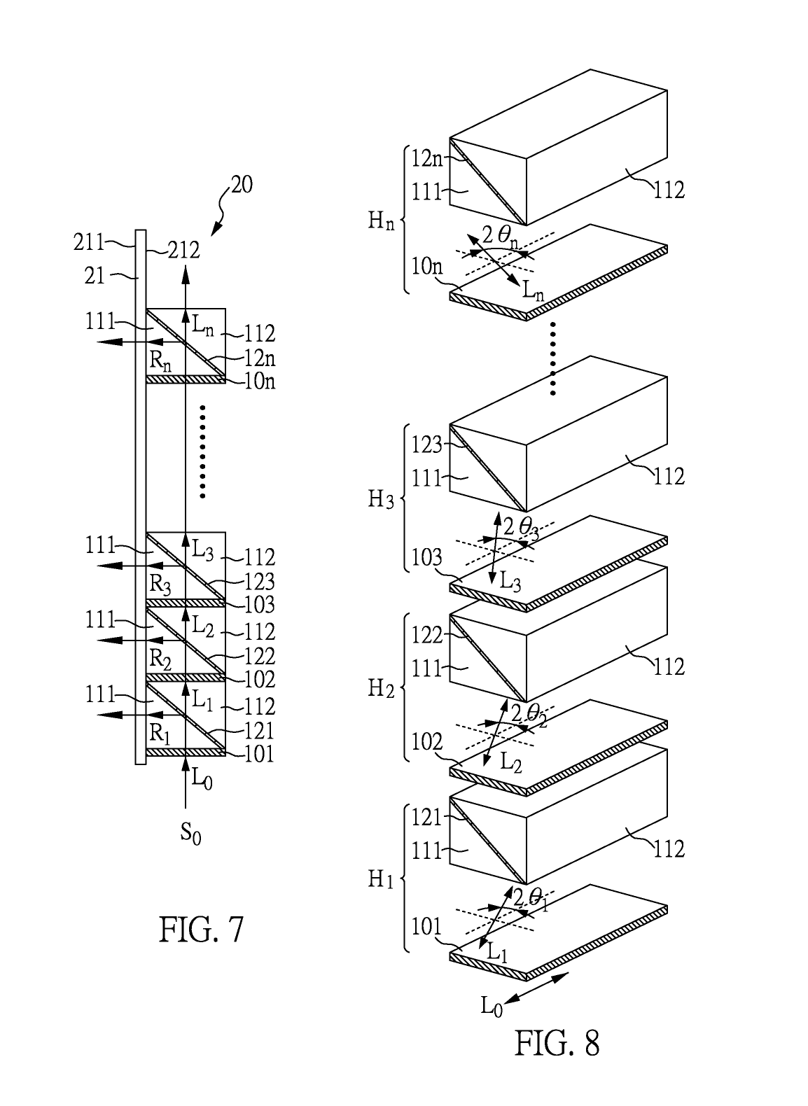

In other embodiments, when incident light L₀ is a non-polarized light, a polarizer may be disposed in front of optical element 101 of light guide unit H₁, as a result, the light incidents into the light guide unit H₁ is a polarized light. Or, the entire light guide plate 10 can be shifted as shown in FIG. 9, so that the penetrating light penetrating into the light guide unit H₂ becomes a polarized light since incident light L₀ penetrates through splitter 121 (herein polarizer).

### [Embodiment 2]

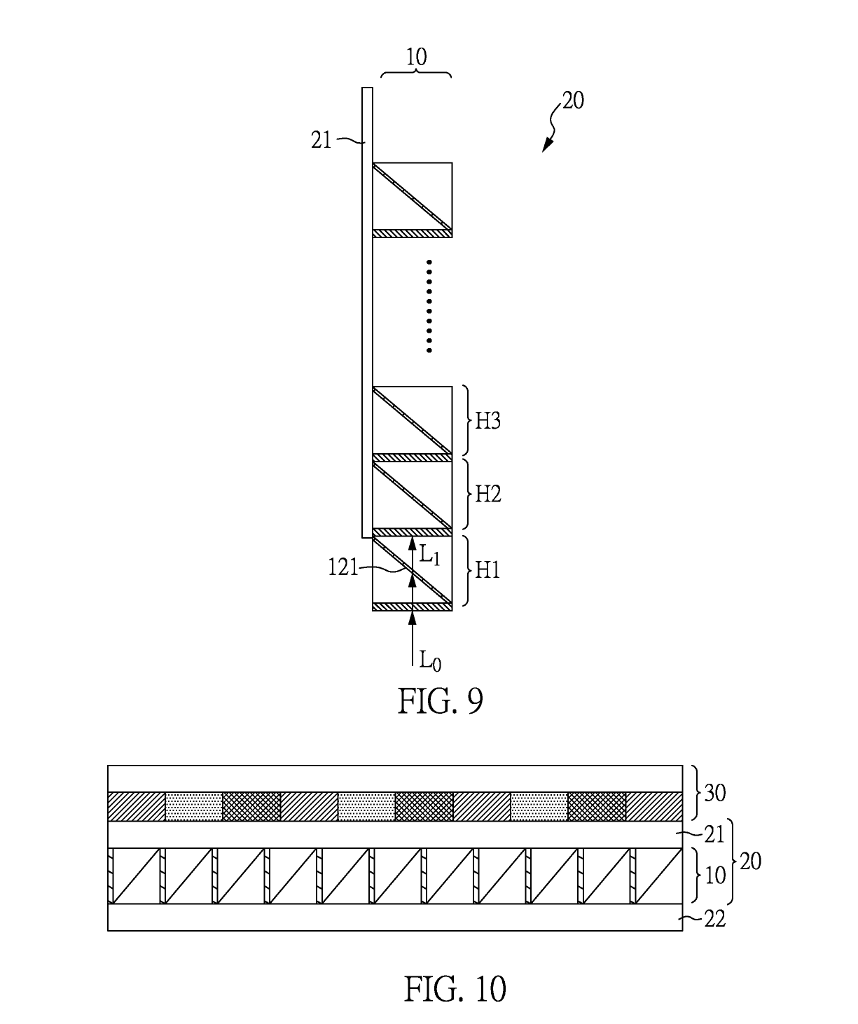

Referring now to FIG. 10, FIG. 10 shows a structure of a transparent display panel, and its preparation method includes disposing display panel 30 on light emitting surface 211 of backlight module 20 accomplished by the aforementioned method; and disposing a polarizer 22 on one side of light guide plate 10 opposing to disposing surface 212 to converse the ambient light to a polarized light. The accomplished transparent display panel is able to show the images displayed by the display panel and show the images of objects behind the display panel at the same time.

The embodiments of the present invention are provided for illustrative purposes. It should be noted, however, that the scope and spirit of the invention as disclosed in the accompanying claims, and the scope of the present invention is not limited by the illustrated embodiment.

What is claimed is:

1. A backlight module, comprising:
a half-wave plate having a disposing surface;
a light guide plate having a plurality of light guide units, and the light guide units are arranged adjacently on the disposing surface; and
a light source irradiating a light into the light guide plate in a direction vertical to a normal line of the disposing surface;
wherein, each of the light guide units respectively comprises: an optical element having a light entrancing surface for the light; a first transparent plate disposed on the optical element, and having a first surface, wherein an angle between the first surface and the light entrancing surface is less than 90 degrees; a splitter disposed on the first surface, and reflecting a portion of the light to the half-wave plate; and a second transparent plate disposed on the splitter, and having a light penetrating surface parallel to the light entrancing surface.

2. The backlight module as claimed in claim 1, wherein the optical element of the light guide unit is a half-wave plate or a polarizer.

3. The backlight module as claimed in claim 1, wherein the light guide plate comprises the light guide units H₁˜Hₙ, which are sequentially arranged, and the intensity of the portion of the light reflected from these light guide units H₁˜Hₙ to the half-wave plate is S₁˜Sₙ respectively;
wherein S₁=S₂=S₃=. . . =S=P₀/n; and
P₀ is the intensity of the light.

4. The backlight module as claimed in claim 1, wherein the light guide plate comprises the light guide units H₁˜Hₙ, which are sequentially arranged, and the intensity of the portion of the light reflected from these light guide units H₁˜Hₙ to the half-wave plate is S₁˜Sₙ respectively; a penetrating light penetrated from the light guide units H₁˜Hₙ deflect 2θ₁˜2θₙ degree respectively; and the intensity of the penetrating light is P₁˜Pₙ respectively, wherein S₁˜Sₙ, 2θ₁˜2θₙ, and P₁˜Pₙ satisfy the following equation (I):
Sₘ=Pₘ₋₁×sin²(2θₘ)=P₀/n (I)
wherein Pₘ=Pₘ₋₁×cos²(2θₘ); and
m is an integer of 1˜n.

5. The backlight module as claimed in claim 4, wherein the optical elements of the light guide units H₁˜Hₙ are half-wave plates, and the optical elements of the light guide units H₁˜Hₙ rotate θ₁˜θₙ respectively in the same direction.

6. The backlight module as claimed in claim 1, wherein the first transparent plate and the second transparent plate are glass plate.

7. The backlight module as claimed in claim 1, wherein the splitter is a polarization light splitter.

8. The backlight module as claimed in claim 1, wherein the angle between the first surface and the light entrancing surface is 30-60 degree.

9. The backlight module as claimed in claim 1, further comprising a polarizer disposed on one surface of the guide light plate opposing to the disposing surface.

10. A transparent display device, comprising:
a display panel;
a backlight module disposed at one side of the display panel, wherein the backlight module comprises: a half-wave plate having a disposing surface; a light guide plate having a plurality of light guide units, the light guide units are arranged adjacently on the disposing surface; and a light source irradiating a light into the light guide plate in a direction vertical to a normal line of the disposing surface;
wherein, each of the light guide units respectively comprises: an optical element having a light entrancing surface for the light; a first transparent plate disposed on the optical element, and having a first surface, wherein an angle between the first surface and the light entrancing surface is less than 90 degrees; a splitter disposed on the first surface, and reflecting a portion of the light to the half-wave plate; and a second transparent plate disposed on the splitter, and having a light penetrating surface parallel to the light entrancing surface.
